(19) United States
(12) Patent Application Publication
(10) Pub. No.: US 2013/0125234 A1
(43) Pub. Date: May 16, 2013

(54) IMAGE FORMING APPARATUS, IMAGE FORMING APPARATUS CONTROL METHOD, AND STORAGE MEDIUM STORING PROGRAM

(71) Applicant: CANON KABUSHIKI KAISHA, Tokyo (JP)

(72) Inventor: Kaori Nishiyama, Tokyo (JP)

(73) Assignee: CANON KABUSHIKI KAISHA, Tokyo (JP)

(21) Appl. No.: 13/653,870

(22) Filed: Oct. 17, 2012

(30) Foreign Application Priority Data
Nov. 10, 2011 (JP) 2011-246863

(51) Int. Cl. G06F 21/00

(52) U.S. Cl. 726/21

(57) ABSTRACT

The history of the output destination of a job is displayed, and selection of a send destination in the history by a user is accepted. It is determined whether the user has an authority to register the selected send destination in a database in which output destination candidates used when executing a job are registered. If it is determined that the user has the authority, an acceptance display is presented to be able to accept an instruction of registration of the send destination in the database.

### BACKGROUND OF THE INVENTION

1. Field of the Invention

The present invention relates to an image forming apparatus which manages a job history, an image forming apparatus control method, and a storage medium storing a program.

2. Description of the Related Art

As the number of functions of an image forming apparatus increases, user setting work on the screen becomes more complicated when executing a job. By reusing past settings, user setting friendliness can be improved.

Japanese Patent Laid-Open No. 2005-297488 discloses a technique of calling an operation history in an image forming apparatus to be operated or a remote image forming apparatus in cooperation with user authentication, and reusing it for a screen operation. Japanese Patent Laid-Open No. 2007-60126 discloses a technique of specifying one job in a job history stored in an image forming apparatus to be operated or a remote image forming apparatus, and printing it again.

It is common practice to reuse the operation history, as described above. However, an image forming apparatus is often shared between a plurality of users, unlike a PC, cellar phone, or the like. If a plurality of users can arbitrarily update a database such as an address book in the image forming apparatus by reusing a job history, this greatly impairs the security of the database. For example, the address book is sometimes used in broadcasting or the like. If an unrelated send destination is registered, no security can be maintained.

### SUMMARY OF THE INVENTION

An aspect of the present invention is to eliminate the above-mentioned problems with the conventional technology. The present invention provides an image forming apparatus which maintains the security of a database in the image forming apparatus, an image forming apparatus control method, and a storage medium storing a program.

The present invention in its first aspect provides an image forming apparatus comprising: an address book database configured to register a send destination of data which can be designated when executing a job; a history display unit configured to display a history of a send destination of data sent when a job was executed; an acceptance unit configured to accept selection of a send destination in the history by a user; a determination unit configured to determine whether the user has an authority to register the send destination in the address book database; and an acceptance display unit configured to, when the determination unit determines that the user has the authority, display an instruction of registration of the send destination in the address book database to be able to accept the instruction.

The present invention in its second aspect provides a method of controlling an image forming apparatus including an address book database configured to register a send destination of data which can be designated when executing a job, comprising: a history display step of displaying a history of a send destination of data sent when a job was executed; an acceptance step of accepting selection of a send destination in the history by a user; a determination step of determining whether the user has an authority to register the send destination in the address book database; and a display step of, when the user is determined in the determination step to have the authority, displaying an instruction of registration of the send destination in the address book database to be able to accept the instruction.

The present invention in its third aspect provides a computer-readable storage medium storing a program for causing a computer to execute a history display step of displaying a history of a send destination of data sent when a job was executed, an acceptance step of accepting selection of a send destination in the history by a user, a determination step of determining whether the user has an authority to register the send destination in an address book database in which a send destination of data that can be designated when executing a job is registered, and a display step of, when the user is determined in the determination step to have the authority, displaying an instruction of registration of the send destination in the address book database to be able to accept the instruction.

The present invention can maintain the security of a database in the image forming apparatus.

Further features of the present invention will become apparent from the following description of exemplary embodiments with reference to the attached drawings.

### BRIEF DESCRIPTION OF THE DRAWINGS

FIG. 1 is a view showing the arrangement of an image forming system;

FIG. 2 is a block diagram showing the arrangement of an image forming apparatus;

FIG. 3 is a table exemplifying a function restriction list;

FIG. 4 is a table exemplifying a user management table;

FIG. 5 is a flowchart showing a processing sequence until the job execution history is stored;

FIG. 6 is a view exemplifying a login screen;

FIG. 7 is a view exemplifying a main menu screen including a function list;

FIG. 8 is a view exemplifying the setting screen of the “scan to send” function;

FIG. 9 is a view exemplifying a screen which displays a job status and history; and

FIGS. 10A and 10B are flowcharts showing a processing sequence of registering a send destination.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same building components, and a repetitive description thereof will be omitted.

### First Embodiment

[Arrangement of Image Forming System]

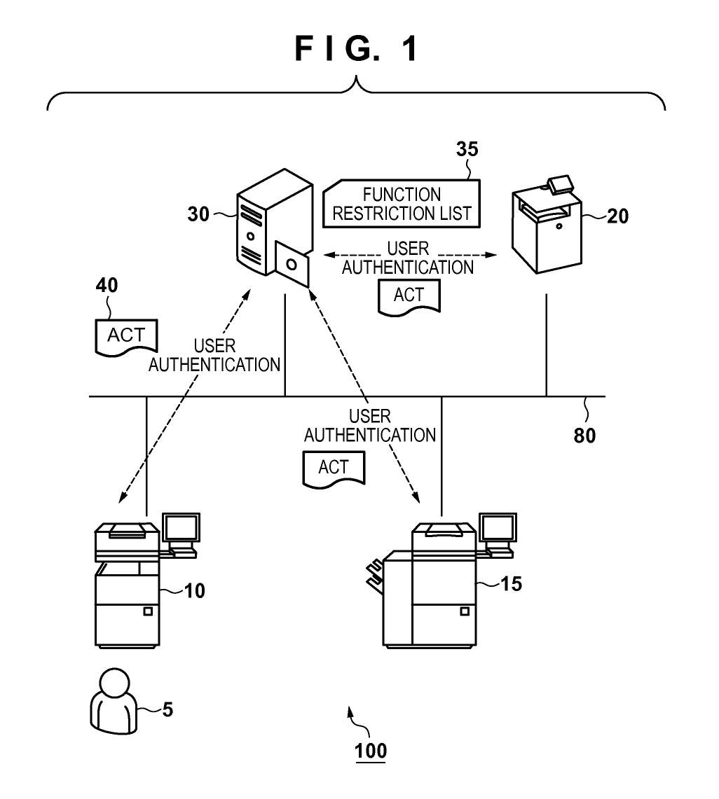

FIG. 1 is a view showing the arrangement of an image forming system 100 including an image forming apparatus 10. In the image forming system 100, the image forming apparatus 10, an image forming apparatus 15, an image forming apparatus 20, and an authentication server 30 are connected via a network 80 such as a LAN to be able to communicate with each other. As shown in FIG. 1, a user 5 logs in to the image forming apparatus 10 and uses the function of the image forming apparatus 10. The authentication server 30 uses a general information processing apparatus such as a PC, and internally holds a function restriction list 35 which defines function restriction information for each user. The function restriction information is information for restricting, for each user, the use of functions which can be provided by each image forming apparatus in the image forming system 100. An example of the function restriction information is information which permits the copy function but inhibits the send function to a predetermined user. Details of the function restriction list will be described later.

An outline of the operation of the image forming system 100 when the user 5 uses a function of the image forming apparatus 10 he wants will be explained. First, the image forming apparatus 10 makes an inquiry to the authentication server 30 based on login information of the user 5, and determines, based on the result, whether to permit execution of the function. The authentication server 30 sends back an ACT (Access Control Token) token 40 to the image forming apparatus 10 based on the function restriction list 35 and the inquiry information notified from the image forming apparatus 10. The ACT token 40 describes function restriction information about functions which are usable or unusable in the image forming apparatus 10 by the user 5. Upon receiving the ACT token 40, the image forming apparatus 10 imposes function restriction on the user 5 by referring to the contents of the ACT token 40. The image forming apparatus 10 can also display an error or warning about a restricted function to the user 5.

[Arrangement of Image Forming Apparatus]

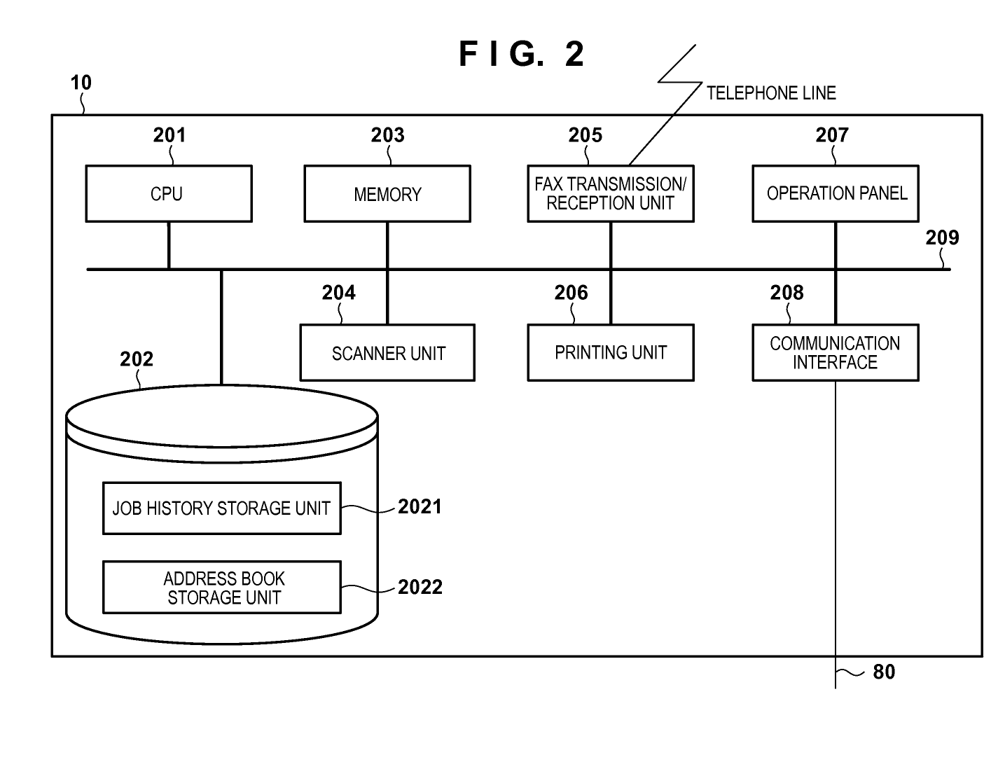

FIG. 2 is a block diagram showing the arrangement of the image forming apparatuses 10, 15, and 20. Although the image forming apparatus 10 will be described, the following description also applies to the image forming apparatuses 15 and 20. The image forming apparatus 10 includes a CPU 201, auxiliary storage unit 202, memory 203, scanner unit 204, FAX transmission/reception unit 205, printing unit 206, operation panel 207, and communication interface 208. These units are connected via an internal bus 209 to be able to communicate with each other. The auxiliary storage unit 202 is formed from a large-capacity storage device such as a hard disk. The auxiliary storage unit 202 saves a large amount of data, and holds program execution codes and the execution history of each job. The job execution history means the history of a copy job, box print job, print job, send job, or the like which has been executed by controlling the scanner unit 204, printing unit 206, FAX transmission/reception unit 205, communication interface 208, or the like by the CPU 201. A job history storage unit 2021 in the auxiliary storage unit 202 holds the job execution history. An address book storage unit 2022 in the auxiliary storage unit 202 holds an output destination candidate to be used when executing a send job. The user can designate the output destination candidate as the destination of a send job. The auxiliary storage unit 202 stores data which needs to be held for a longer time than in the memory 203 to be described below.

The memory 203 includes a ROM which stores various programs to be executed by the CPU 201, and a RAM which temporarily stores data necessary for control. The scanner unit 204 optically reads a printing medium such as a document. The FAX transmission/reception unit 205 is connected to a telephone line, and performs FAX transmission/reception to/from the outside. The printing unit 206 prints an image or the like on a printing medium based on data. The printing unit 206 prints on a printing medium by, for example, discharging ink from a printhead. The operation panel 207 displays a user interface screen to the user. Also, the operation panel 207 accepts an instruction from the user via the user interface screen. The communication interface 208 performs e-mail transmission, SMB transmission, and transmission/reception of data necessary for authentication via the network 80.

The CPU 201 executes various programs, and controls the overall image forming apparatus 10. The CPU 201 expands, in the memory 203, a program stored in the auxiliary storage unit 202, and executes it. As a result, the CPU 201 designates the respective units and implements various functions such as scanning, printing, and transmission. The CPU 201 determines whether to permit each user of the image forming apparatus 10 to use various functions. The determination method will be described later. The CPU 201 acquires function restriction information of each user serving as the determination criterion from the authentication server 30 via the communication interface 208 and network 80. The CPU 201 designates the respective units in accordance with the acquired function restriction information, and executes function restriction for each user.

[Function Restriction List]

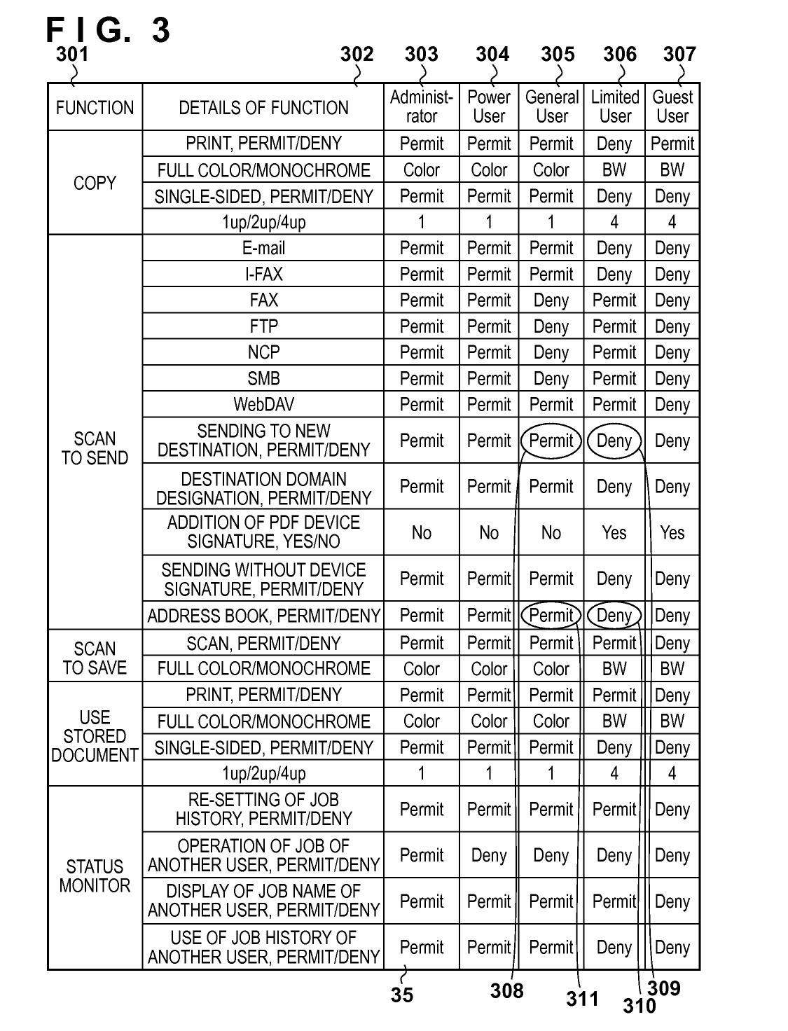

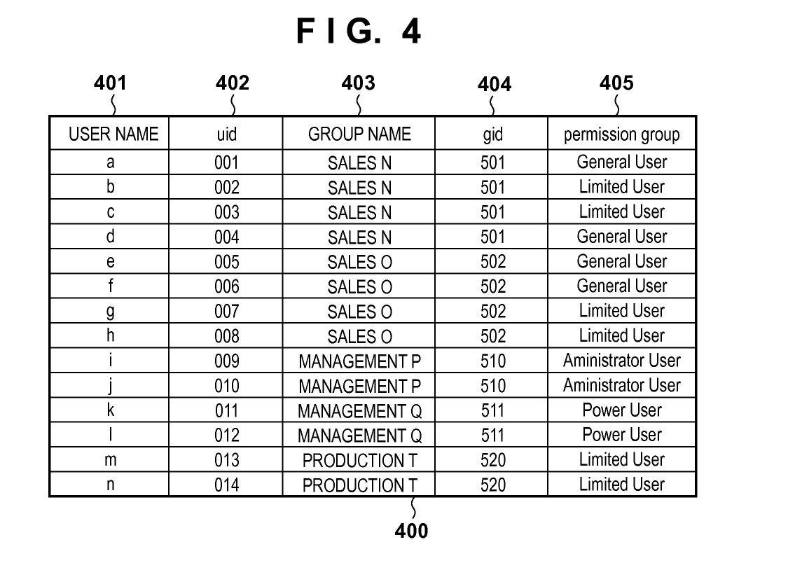

The function restriction list 35 held in the authentication server 30 will be explained with reference to FIGS. 3 and 4. FIG. 3 is a table exemplifying the function restriction list 35. Columns 301 to 307 shown in FIG. 3 are columns of the table. Data 308 to 311 are pieces of function restriction information corresponding to respective user attributes defined in the function restriction list 35. “Permit” defined as function restriction information represents that a user having this attribute is permitted to use the function. “Deny” defined as function restriction information represents that a user having this attribute is inhibited from using the function. “Color” in the function restriction list 35 represents that color printing is permitted. “BW” represents that only monochrome printing is permitted. When a numerical value is defined, or “Yes” or “No” is defined, this is interpreted with a meaning corresponding to contents defined by details of each function in the column 302.

The column 301 represents functions provided by each image forming apparatus. The column 302 represents details of each function represented in the column 301. The columns 303 to 307 represent pieces of function restriction information for respective user attributes. The column 303 represents function restriction information of a user having an attribute “Administrator”, and the column 304 represents function restriction information of a user having an attribute “Power User”. The column 305 represents function restriction information of a user having an attribute “General User”, and the column 306 represents function restriction information of a user having an attribute “Limited User”. The column 307 represents function restriction information of a user having an attribute “Guest User”. For example, in the embodiment, a user having the attribute “General User” is permitted to use the new destination send function of newly inputting a destination and sending data, and the address book edit function, as represented by the data 308 and 311. A user having the attribute “Limited User” is inhibited from using the new destination send function and address book edit function, as represented by the data 309 and 310.

[User Management Table]

The image forming apparatus 10 internally holds a user management table as shown in FIG. 4. By looking up the user management table as shown in FIG. 4, the image forming apparatus 10 can recognize the attribute of the user 5. FIG. 4 is a table exemplifying a user management table 400. The user management table 400 manages a user name 401, UID 402, group name 403, GID 404, and permission group 405 in correspondence with each other. For example, for user a, the UID 402 is “001”, the group name 403 is “sales N”, the GID 404 is “501”, and the permission group 405 is “General User”. The permission group 405 represents the attribute.

[Execution of Job]

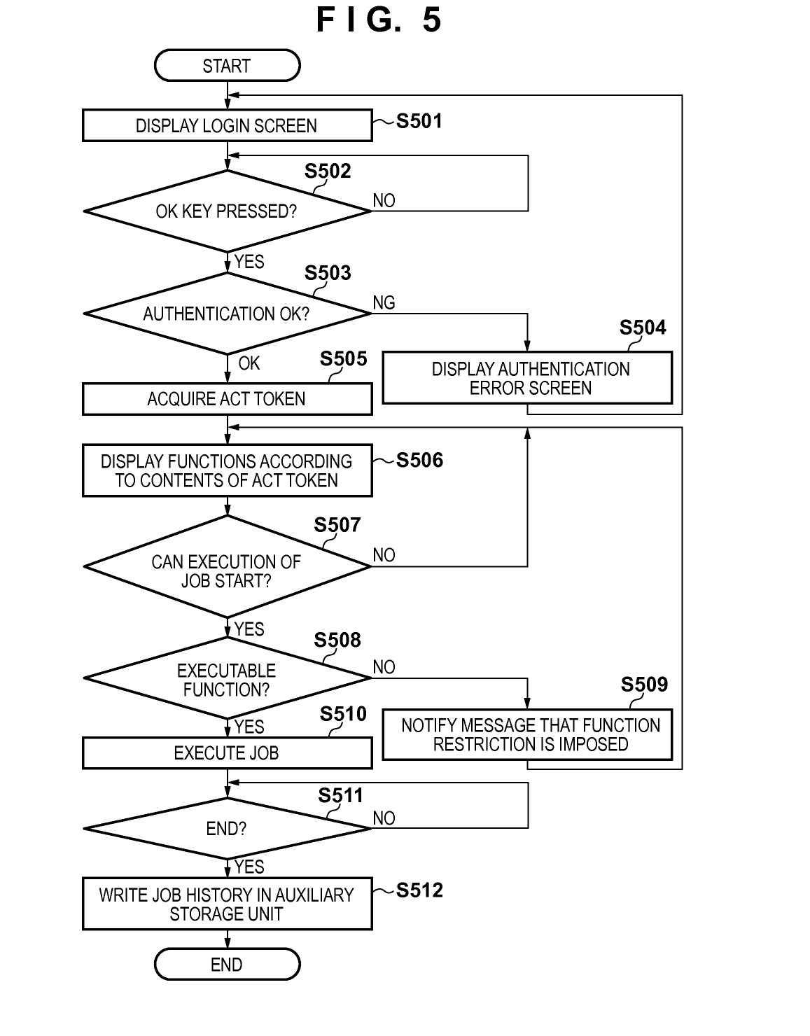

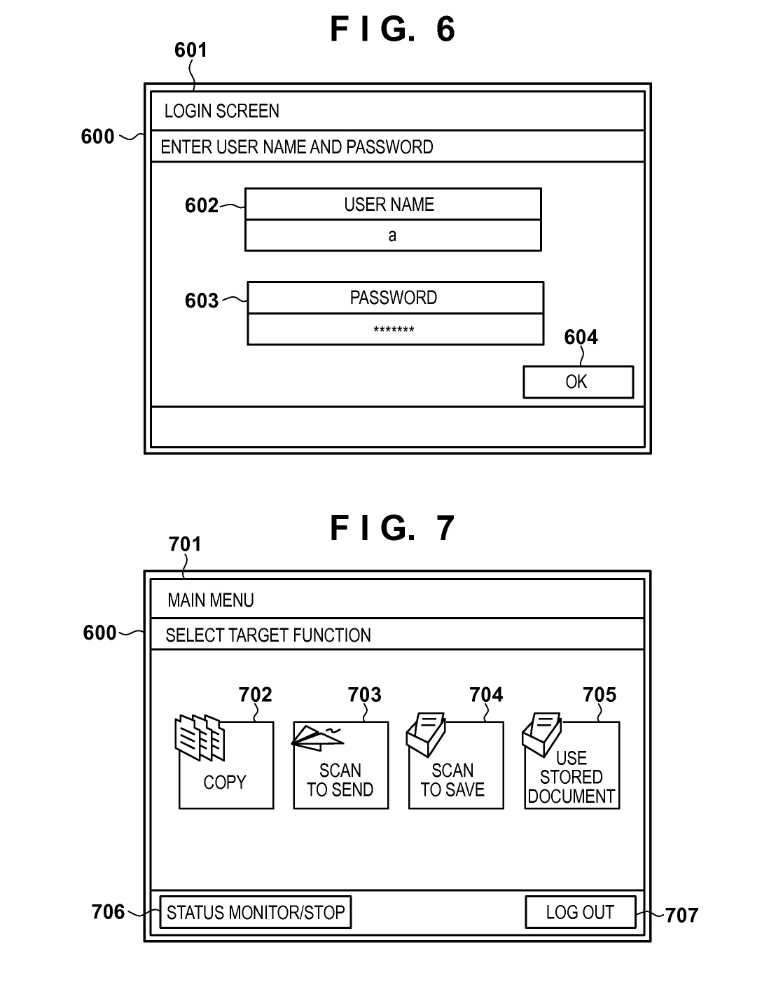

Processing until a job is executed and the execution history of the job is stored in the job history storage unit 2021 of the auxiliary storage unit 202 will be explained with reference to the flowchart of FIG. 5. Note that this processing is implemented by expanding a program stored in the auxiliary storage unit 202 into the memory 203 and executing it by the CPU 201. First, in step S501, the user 5 logs in to the image forming apparatus 10. At this time, the operation panel 207 of the image forming apparatus 10 displays a screen as shown in FIG. 6. As shown in FIG. 6, a liquid crystal operation unit 600 in the operation panel 207 displays a login screen 601. The login screen 601 displays an input field 602 for inputting a user name, an input field 603 for inputting a password, and an OK key 604. In the input field 602, a user name such as “a” is input. In the input field 603, a password corresponding to the user name input to the input field 602 is input. In step S502, it is determined whether the user 5 has pressed the OK key 604. If it is determined that the user 5 has pressed the OK key 604, authentication for permitting the user 5 to log in, and function restriction information are inquired of the authentication server 30 in step S503. The processing in step S502 is repeated until it is determined that the user 5 has pressed the OK key 604. If the user 5 is authenticated and permitted to log in, the CPU 201 acquires the ACT token 40 from the authentication server 30 in step S505. If the user 5 is not authenticated and inhibited from login, an authentication error screen is displayed (step S504), and the process returns again to step S501 to display the login screen.

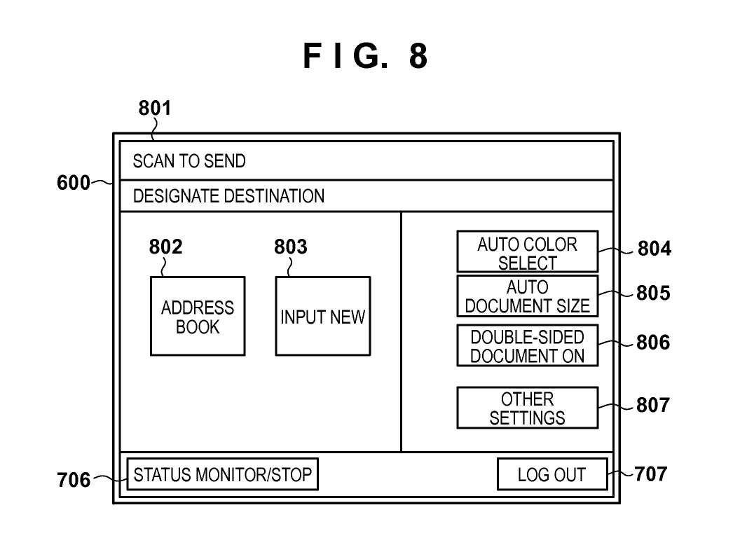

In step S506, the CPU 201 displays a main menu screen including a function list as shown in FIG. 7 in accordance with the contents of the ACT token 40 acquired in step S505. FIG. 7 is a view exemplifying a main menu screen 701. A button 702 in FIG. 7 is used to execute the copy function. When the user presses the button 702, a setting screen for copying, by the printing unit 206, an image read by the scanner unit 204 appears. A button 703 is used to execute the “scan to send” function. When the user presses the button 703, a setting screen for externally sending an image read by the scanner unit 204 via the FAX transmission/reception unit 205 or communication interface 208 appears. A button 704 is used to execute the “scan to save” function. When the user presses the button 704, a setting screen for saving an image read by the scanner unit 204 in the auxiliary storage unit 202 appears. A button 705 is used to execute the “use saved document” function. When the user presses the button 705, a setting screen for copying an image saved in the auxiliary storage unit 202 by the printing unit 206 or externally sending it via the FAX transmission/reception unit 205 or communication interface 208 appears. A button 706 is a status monitor button. When the user presses the button 706, a screen for checking the status of a copy/print job, send job, reception job, or save job during processing, or stopping processing appears. A button 707 is a logout button. When the user presses the button 707, logout is executed.

A case in which the user 5 having a user name “a” logs in to the image forming apparatus 10 will be explained. The CPU 201 looks up the user management table shown in FIG. 4, and recognizes that “General User” is set as the attribute in the permission group 405 for the user name “a”. Then, the CPU 201 looks up the table shown in FIG. 3, and recognizes that “Permit” is set for the copy function, “scan to send” function, “scan to save” function, and “use saved document” function for the user having the attribute “General User” (these functions are permitted). Also, the CPU 201 recognizes that “Deny” is set for all functions other than the copy function for the user having the attribute “Guest User”, that is, these functions are inhibited.

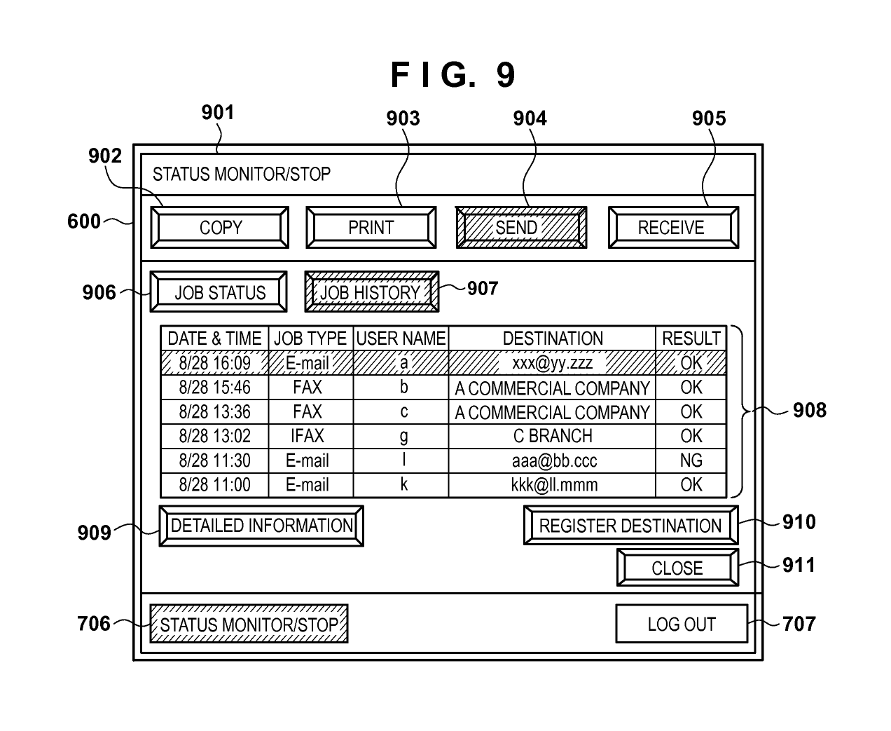

A case in which the user 5 having the attribute “General User” presses the button 703 and selects the “scan to send” function will be explained. FIG. 8 exemplifies a setting screen displayed when the user presses the button 703 and selects the “scan to send” function. When selecting a send destination already registered in the address book storage unit 2022 and sending data, the user 5 presses an address book button 802 and sets the send destination. When newly inputting a send destination and sending data, the user 5 presses an “input new” button 803 and sets the send destination. Buttons 804 to 807 are send function setting buttons, and the user can change the document setting, send setting, and the like by pressing the respective buttons. As shown in FIG. 3, for a user having the attribute “General User”, “Permit” is set for the function of newly inputting a send destination and sending data. Hence, the user can press the “input new” button 803 and newly input a send destination. To the contrary, when “Deny” is set, the “input new” button 803 is displayed with hatching or the like to inhibit the user from using it.

When the CPU 201 detects pressing of the address book button 802, it acquires a registered send destination information list from the address book storage unit 2022, and displays it. The user 5 selects, from the list, a send destination he wants, and designates the start of sending. When the CPU 201 accepts pressing of the “input new” button 803, it displays, on the operation panel 207, a screen (not shown) for selecting a send mode. In this case, a destination input screen is displayed based on a send mode selected by the user 5, and the user 5 inputs a destination he wants, and designates the start of sending.

The CPU 201 accepts the send start instruction, and determines whether execution of the job can start (step S507). If the CPU 201 determines that execution cannot start owing the network communication status or the like, the process returns to step S506. If the CPU 201 determines that execution can start, it determines whether the user 5 can execute the designated function (step S508). For example, when the user attribute is “General User”, sending by FAX, FTP, NCP, SMB, and WebDAV is permitted, but sending by E-mail and I-FAX is inhibited. If the destination contains E-mail or I-FAX, the CPU 201 determines that sending is inhibited, displays a warning to this effect, and returns to step S506 (step S509). In this case, an unusable function may be displayed with hatching or the like in addition to the warning display.

If the CPU 201 determines in step S508 that the user 5 can execute the designated function, it executes the function (step S510). The CPU 201 determines whether the job which executes the function has ended (step S511). If the CPU 201 determines that the job has not ended, it repeats the processing in step S511 until the CPU 201 determines that the job has ended. If the CPU 201 determines that the job has ended, it writes the contents set in sending and information about the sending result in the job history storage unit 2021 of the auxiliary storage unit 202 (step S512).

[List Display of Job Execution History]

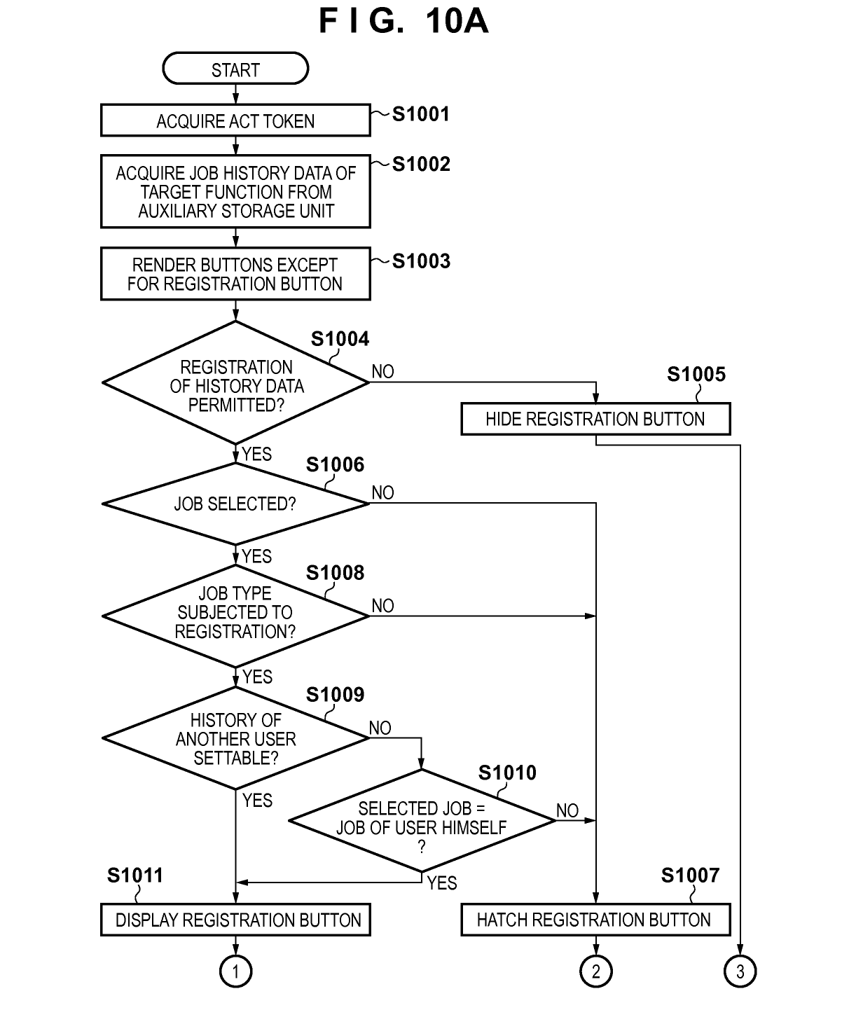

When the user presses the status monitor button 706, the job history written in the job history storage unit 2021 is displayed as a list. FIG. 9 exemplifies a screen which displays a job status and history display list. A status monitor screen 901 displays function buttons, that is, a copy function button 902, print function button 903, send function button 904, and reception function button 905. When the user presses each button, the status and history of a job regarding a function corresponding to the button are displayed. For example, a case in which the user has pressed the send function button 904 will be explained. When the user presses the send function button 904 and then a job status button 906, the status of a send job during sending is displayed. When the user presses the send function button 904 and then a job history button 907, the statuses of execution-completed send jobs are listed and displayed. A case in which the user has pressed the job history button 907 will be explained.

A job history list 908 is a list of execution-completed send jobs. “Date & time” represents the date and time when sending was completed, “job type” represents the type of send job in execution, and “user name” represents the name of a user who executed the job. “Destination” displays a send destination registered in the address book storage unit 2022 for a job for which a name is described in the send destination of a send job, and a newly input/sent send destination for a send job for which no name is described. “Result” represents normal end or abnormal end of sending. When the user presses a detailed information button 909, details of the setting contents of each send job are displayed. When the user presses a destination registration button 910 (registration instruction), the destination of a send job selected in the job history list 908 is registered in the address book storage unit 2022 of the auxiliary storage unit 202. When the user presses a close button 911, the status monitor screen 901 disappears, and the display returns to a previous screen. As shown in FIG. 9, the history of a send job executed according to the flowchart of FIG. 5 is displayed as represented by the job history list 908.

[Registration of Send Destination]

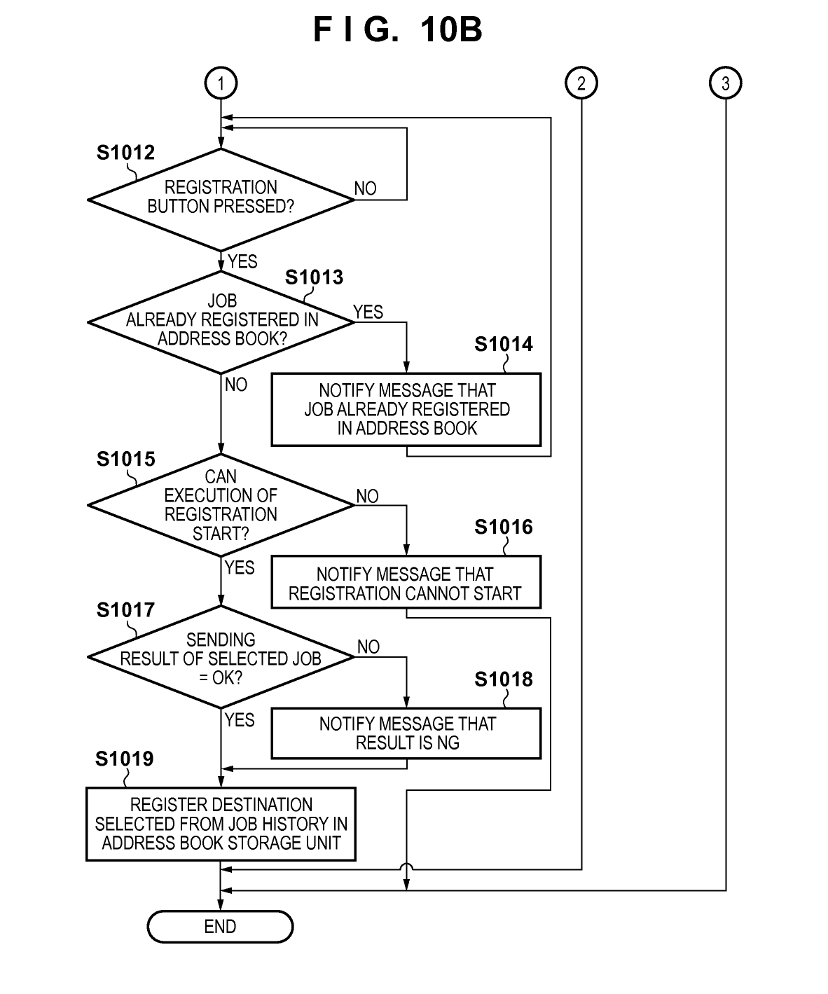

FIG. 10A and 10B are flowcharts showing a processing sequence of registering the send destination of a send job selected from the send job history list in the address book storage unit 2022. Note that this processing is implemented by expanding a program stored in the auxiliary storage unit 202 into the memory 203 and executing it by the CPU 201. When the user 5 displays the job history list 908, the CPU 201 acquires again the ACT token 40 from the authentication server 30 (step S1001). By acquiring the ACT token 40 again even in displaying the job history list 908, function restriction can be appropriately imposed in accordance with the current situation even when the operation restriction on the user 5 has changed. Then, the CPU 201 acquires job history data of a corresponding function from the job history storage unit 2021 in the auxiliary storage unit 202 (step S1002), and renders buttons except for the destination registration button 910 (step S1003).

The CPU 201 determines whether the registration function to the address book storage unit 2022 is permitted to the user 5 (step S1004). For example, if an attribute set in the permission group 405 for the user 5 is “Limited User” or “Guest User”, the address book edit function is inhibited. In this case, the CPU 201 does not display the destination registration button 910 (step S1005). For example, if the attribute is “General User”, the CPU 201 recognizes that the address book edit function is permitted, and advances to the next processing.

The CPU 201 determines whether the user has selected, from the history of the job history list 908, the send destination of a send job he wants (step S1006). If the CPU 201 determines that the user has not selected the send destination, the destination registration button 910 is displayed by hatching or the like not to accept an instruction (step S1007). If the CPU 201 determines that the user has selected a send job he wants, it determines whether the selected send job is of a job type subjected to registration in the auxiliary storage unit 202. If the CPU 201 determines that the selected send job is not of a job type subjected to registration, the destination registration button 910 is displayed by hatching or the like not to accept an instruction (step S1008). A job not of a job type subjected to registration is a job which targets adjustment or maintenance. Such a job need not be registered and managed in the address book storage unit 2022, and is determined not to be of a job type subjected to registration. If the CPU 201 determines that the selected send job is of a job type subjected to registration, it determines whether the re-setting function of the job history of another user is permitted to the user 5 (step S1009). For example, if the attribute of the user 5 is “Guest User”, the re-setting function of the job history of another user is inhibited, as shown in FIG. 3. In this case, the CPU 201 determines whether the selected send job is a job of the user 5 himself (step S1010). If the CPU 201 determines that the selected send job is not a job of the user 5 himself, that is, is a job of another user, the destination registration button 910 is displayed by hatching or the like not to accept an instruction (step S1007). If the CPU 201 determines that the selected send job is a job of the user 5 himself, the destination registration button 910 is displayed to be able to accept an instruction (step S1011).

Then, the CPU 201 determines whether the user has pressed the destination registration button 910 (step S1012). The processing in step S1012 is repeated until it is determined that the user has pressed the destination registration button 910. If the CPU 201 determines that the user has pressed the destination registration button 910, it determines whether the send destination of the selected send job is a send destination already registered in the address book storage unit 2022 (step S1013). If the CPU 201 determines that the send destination of the selected send job is a send destination already registered in the address book storage unit 2022, registrations will overlap, so the CPU 201 notifies the user of a warning indicative of this, and then the process returns to step S1012 (step S1014). The job history list 908 may display the send destination to notify the user that the send destination has already been registered in the address book storage unit 2022.

If the CPU 201 determines that the send destination of the selected send job has not been registered yet in the address book storage unit 2022, it determines whether execution of registration in the address book storage unit 2022 can start. For example, when another job is being executed such that it waits for the start of sending after scanning, the address book storage unit 2022 may be used during the execution, and the CPU 201 displays a warning that no registration can start (step S1016).

If the CPU 201 determines that registration can start, it determines which of normal end and abnormal end has been registered in the history as the sending result of the selected send job (step S1017). If the CPU 201 determines that abnormal end has been registered in the history, the sending destination may be erroneous, and the CPU 201 displays a warning to this effect to the user (step S1018). In the warning display, a confirmation button or the like may be displayed, and if the user presses the button, the process may advance to step S1019. If the CPU 201 determines that normal end has been registered in the history, it registers the send destination of the selected send job in the address book storage unit 2022 (step S1019).

The above processing may include a step of determining whether registration in the address book storage unit 2022 is possible after displaying the destination registration button 910 in step S1011. In this step, for example, if the number of registrations in the address book storage unit 2022 has reached an upper limit value, the CPU 201 determines that no additional registration is possible, and displays a warning indicative of this. In the embodiment, if a warning is displayed in step S1013 or S1017, registration is temporarily suspended, and the process waits for an instruction from the user.

The embodiment has exemplified a send destination, but the destination may be a printout destination instead of the send destination. In the above description, the authentication server 30 connected to the image forming apparatuses 10, 15, and 20 via the network 80 holds the function restriction list 35. However, the image forming apparatus may internally hold the function restriction list 35.

As described above, in the system which restricts usable functions for each user, even when updating information of an address book database such as the address book storage unit 2022 using operation history information, function restriction is imposed based on the user authority. As a result, updating of database information by an unauthorized user can be restricted to prevent illicit tampering of the database and maintain the security.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-246863, filed Nov. 10, 2011, which is hereby incorporated by reference herein in its entirety.

What is claimed is:

1. An image forming apparatus comprising:
an address book database configured to register a send destination of data which can be designated when executing a job;
a history display unit configured to display a history of a send destination of data sent when a job was executed;
an acceptance unit configured to accept selection of a send destination in the history by a user;
a determination unit configured to determine whether the user has an authority to register the send destination in said address book database; and
an acceptance display unit configured to, when said determination unit determines that the user has the authority, display an instruction of registration of the send destination in said address book database to be able to accept the instruction.

2. The apparatus according to claim 1, wherein said determination unit determines whether the user has an authority to register, in said address book database, the send destination, wherein the selection of the send destination has been accepted by said acceptance unit.

3. The apparatus according to claim 1, further comprising a table configured to define a user having the authority to register the send destination in said address book database,
wherein said determination unit refers said table and determines whether the user has the authority to register the selected send destination in said address book database.

4. The apparatus according to claim 1, further comprising:
a registration determination unit configured to, in a case where the instruction of registration is accepted, determine whether the selected send destination has already been registered in said address book database; and
a first warning display unit configured to, when said registration determination unit determines that the selected send destination has already been registered in said address book database, display a warning that the selected send destination has already been registered in said address book database.

5. The apparatus according to claim 1, further comprising:
a job determination unit configured to, in a case where the instruction of registration is accepted, determine that a execution result of a job corresponding to the selected send destination is normal or abnormal; and
a second warning display unit configured to, in a case where said job determination unit determines that the execution result is abnormal, display a warning that the job has ended abnormally.

6. The apparatus according to claim 4, further comprising a control unit configured to, in a case where the warning is displayed, inhibit registration of the selected send destination in said address book database.

7. A method of controlling an image forming apparatus including an address book database configured to register a send destination of data which can be designated when executing a job, comprising:
a history display step of displaying a history of a send destination of data sent when a job was executed;
an acceptance step of accepting selection of a send destination in the history by a user;
a determination step of determining whether the user has an authority to register the send destination in the address book database; and
a display step of, when the user is determined in the determination step to have the authority, displaying an instruction of registration of the send destination in the address book database to be able to accept the instruction.

8. A computer-readable storage medium storing a program for causing a computer to execute
a history display step of displaying a history of a send destination of data sent when a job was executed,
an acceptance step of accepting selection of a send destination in the history by a user,
a determination step of determining whether the user has an authority to register the send destination in an address book database in which a send destination of data that can be designated when executing a job is registered, and
a display step of, when the user is determined in the determination step to have the authority, displaying an instruction of registration of the send destination in the address book database to be able to accept the instruction.
